(19) United States
(12) Patent Application Publication
(10) Pub. No.: US 2017/0198677 A1
(43) Pub. Date: Jul. 13, 2017

(54) HYDROELECTRIC GENERATION APPARATUS

(71) Applicant: Kuo-Chang Huang, Tainan City (TW)

(72) Inventor: Kuo-Chang Huang, Tainan City (TW)

(21) Appl. No.: 15/399,811

(22) Filed: Jan. 6, 2017

(30) Foreign Application Priority Data
Jan. 11, 2016 (TW) 105100708

(51) Int. Cl. F03B 13/08; F03B 3/12; H02K 7/18; F03B 7/00

(52) U.S. Cl. CPC F03B 13/08; F03B 7/00; F03B 3/121; H02K 7/1823

(57) ABSTRACT

In a hydroelectric generation apparatus placed in a water body, a dam unit divides the water body into a high-water level region and a low-water level region. A drive unit includes a shaft and a vane unit. The shaft extends transversely of a flow direction of the water flow of the water body. The vane unit extends helically around the shaft. The vane unit has a lower vane portion beneath the shaft. The lower vane portion is propelled by the water flow to rotate the shat. A power generation unit is driven by the drive unit to generate power.

### CROSS-REFERENCE TO RELATED APPLICATION

This application claims priority to Taiwanese Patent Application No. 105100708, filed on Jan. 11, 2016.

### FIELD

The disclosure relates to a power generation apparatus, and more particularly to a hydroelectric generation apparatus.

### BACKGROUND

In recent years, because non-polluting power generation system has attracted increased attention, there is a need for an apparatus with low cost for generating power from an environmentally clean energy source, such as wind, solar or water.

### SUMMARY

Therefore, an object of the disclosure is to provide a hydroelectric generation apparatus that can generate power by utilizing tidal or river currents.

According to the disclosure, a hydroelectric generation apparatus for being placed in a water body having a water flow, which includes a dam unit, a drive unit and a power generation unit.

The dam unit includes a dam body and a flow passage. The dam body is able to divide the water body into a high-water level region and a low-water level region. The flow passage is formed in the dam body in fluid communication with the high-water and low-water level regions. The flow passage allows the water flow to flow from the high-water level region to the low-water level region.

The drive unit includes a shaft and a vane unit. The shaft is disposed horizontally and rotatably in the flow passage and extends transversely of a flow direction of the water flow. The vane unit extends helically around the shaft. The vane unit has an upper vane portion above the shaft, and a lower vane portion beneath the shaft. The lower vane portion is propelled by the water flow to rotate the shaft.

The power generation unit is driven by the drive unit to generate power.

### BRIEF DESCRIPTION OF THE DRAWINGS

Other features and advantages of the disclosure will become apparent in the following detailed description of the embodiments with reference to the accompanying drawings, of which:

FIG. 1 is a schematic front view of a hydroelectric generation apparatus according to a first embodiment of the present disclosure;

FIG. 2 is a sectioned view taken along a line II-II of FIG. 1;

FIG. 3 is a fragmentary sectional top view, illustrating a drive unit of the first embodiment;

FIG. 4 is a fragmentary sectional top view of a drive unit in a second embodiment;

FIG. 5 is a fragmentary sectional side view of the drive unit in FIG. 4;

FIG. 6 is a schematic front view of a third embodiment of the present disclosure;

FIG. 7 is a schematic front view of a hydroelectric generation apparatus according to a fourth embodiment of the present disclosure;

FIG. 8 is a sectioned view taken along a line VIII-VIII of FIG. 7; and

FIG. 9 is a fragmentary sectional view, illustrating the drive unit of the fourth embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

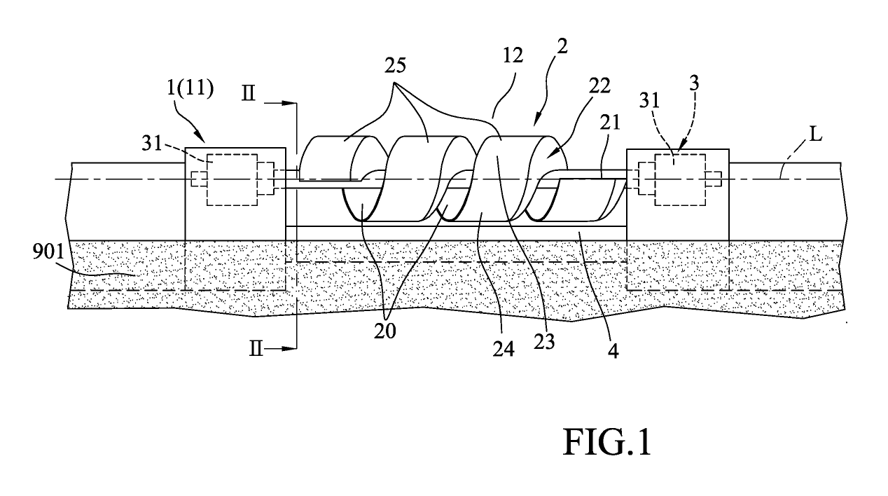

Referring to FIGS. 1 to 3, a hydroelectric generation apparatus according to a first embodiment of the present disclosure is suitable for being placed in a water body 900 such as a river or ocean. The water body 900 has a streambed 901 and a water flow 902 having a flow direction (F) above the streambed 901. The hydroelectric generation apparatus includes a dam unit 1, a drive unit 2, a power generation unit 3 and a streambed-protective unit 4.

The dam unit 1 includes a dam body 11 to divide the water body 900 into a high-water level region 903 and a low-water level region 904, and a flow passage 12 formed in the dam body 11 in fluid communication with the high-water and low-water level regions 903, 904. The water flow 902 in the high-water level region 903 is higher than the water flow 902 in the low-water level region 904. The different water levels are formed due to a blocking action of the dam body 11, which limits water to flow only through the flow passage 12. Because the amount of the water flow 902 flowing through the flow passage 12 is limited, the water level in the high-water level region 903 is higher than that of the low-water level region 904.

The drive unit 2 includes a shaft 21 and a vane unit 22. The shaft 21 is disposed horizontally and rotatably in the flow passage 12 and has an axis (L) extending transversely of the flow direction (F) of the water flow 902. The vane unit 22 extends helically around the shaft 21. The vane unit 22 has an upper vane portion 23 above the shaft 21, and a lower vane portion 24 beneath the shaft 21. In this embodiment, the water flow 902 is below the shaft 21. The lower vane portion 24 receives a propelling force of the water flow 902 to drive rotation of the shaft 21.

The vane unit 22 has a plurality of helical rings 25 spaced apart from and connected to one another along the shaft 21. Every two adjacent ones of the helical rings 25 define a gap 20 therebetween. Each helical ring 25 has a connection wall 251 that is helically wound around the shaft 21 and that is inclined to the flow direction (F) of the water flow 902, and a surrounding wall 252 that extends axially of the shaft 21 from the connection portion 251 and that is spaced apart from the shaft 21. In practice use, there may be a reinforcement rib (not shown) disposed between the connection wall 251 and the shaft 21 to reinforce stability of the connection wall 251 and the shaft 21. The surrounding wall 252 may be hollow to reduce the entire density of the vane unit 22, so that the entire density of the vane unit 22 may be approximate to fluid density.

Because the connection wall 251 is inclined to the flow direction (F) of the water flow 902, when the water flow 902 contacts the connection wall 251, the flow direction (F) of the water flow 902 is changed by the connection wall 251, and the connection wall 251 is subjected to a reaction force from the water flow 902 to rotate the vane unit 22. With the surrounding wall 252 to increase a contact area between the helical ring 25 and the water flow 902, the reaction force of the water flow 902 on the helical ring 25 can be enhanced. Further, because the surrounding wall 252 extends transversely to the flow direction (F) of the water flow 902, the surrounding wall 252 may limit the water flow 902 and collect water energy. Therefore, when flowing through the helical rings 25, the water flow 902 may efficiently transmit its kinetic energy to the vane unit 22 to provide a torsion force for rotation of the shaft 21.

The power generation unit 3 includes two spaced-apart generators 31 disposed in the dam body 11. The generators 31 are coupled to the shaft 21 to convert the kinetic energy from the shaft 21 into an electrical power. In use, each generator 31 may be one of an axial magnetic field generator or a radial magnetic field generator.

The streambed protector unit 4 includes a threshold member 41 that extends along the axis (L) of the shaft 21 and that is disposed beneath the lower vane portion 24. The threshold member 41 is inserted into a streambed 901 of the water body 900, and has an upper end adjacent to the lower vane portion 24 to prevent water from flowing through a gap between the lower vane portion 24 and the threshold member 41.

The streambed protector unit 4 is utilized to protect the streambed 901. In particular, when flowing through the drive unit 2, the water flow 902 may scour the streambed 901. If the streambed protector unit 4 is not provided, the water flow 902 may directly scour out and damage the streambed 901 and even produce an indentation in the streambed 901. When the water flow 902 flows through the indentation, the propelling force of the water flow 902 may be unable to effectively apply to the drive unit 2. Through the protection of the streambed protector unit 4, even if the water flow 902 scours out the streambed 901, because the threshold member 41 is constantly in close proximity to the lower vane portion 24, the water flow 902 will not flow idly beneath the lower vane portion 24, and the energy of the water flow 902 can be effectively transmitted to the drive unit 2.

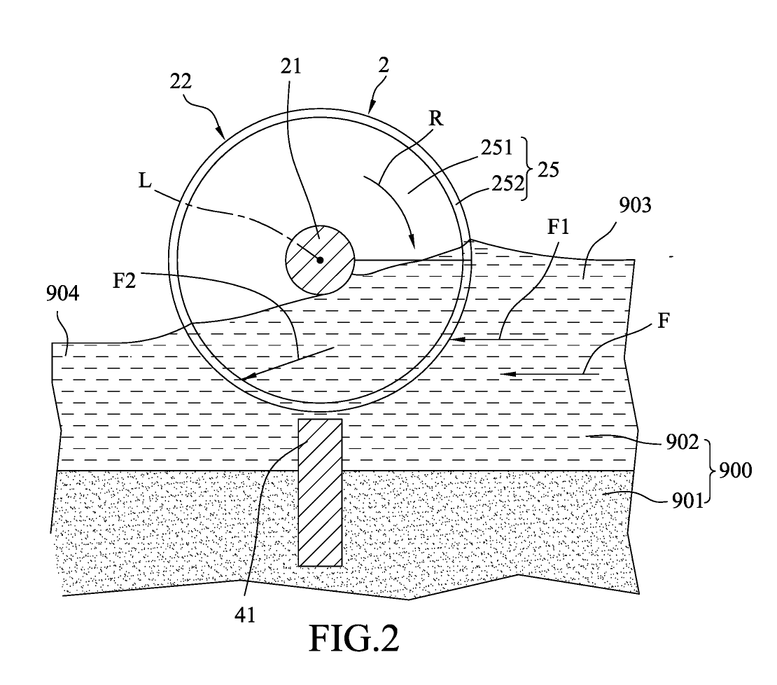

In practice use, when the hydroelectric generation apparatus of the present disclosure is placed in a river, the high-water level region 903 is located at an upstream side of the river (see the right part in FIG. 2), and the low-water level region 904 is located at a downstream side of the river (see the left part in FIG. 2). Because the dam body 11 blocks the water flow 902, the water flow 902 is raised in the high-water level region 903, and flows from the high-water level region 903 to the low-water level region 904 through the flow passage 12, so that the drive unit 2 is driven by the water flow 902 passing through the flow passage 12. In addition, an inception unit (not shown), e.g. a fence or a screen, may be placed upstream of the hydroelectric generation apparatus to prevent tree branches, garbage or dead animals from entering the flow passage 12, thereby protecting the drive unit 2. In some cases, the inception unit may have strength to resist impact from large stones or other heavy objects.

When the hydroelectric generation apparatus of the present disclosure is used in an ocean, the dam unit 1 may define a zone within the ocean. The high-water level region 903 is located outside of the zone (see the right part of the water body 900 in FIG. 2), and the low-water level region 904 is located inside of the zone (see the left part of the water body 900 in FIG. 2). At high tide, the water flows from the high-water level region 903 into the low-water level region 904 through the flow passage 12 to drive operation of the drive unit 2, and the low-water level region 904 stores the water until the water level of the low-water level region 904 is equal to that of the high-water level region 903. At low tide, the water level of the high-water level region 903 is lower than that of the low-water level region 904, so that the flow direction (F) of the water flow 902 is reversed from the low-water level region 904 to the high-water level region 903. In addition, two inception units (not shown) may be placed in two opposite sides of the hydroelectric generation apparatus, respectively.

It is worth mentioning that, at high tide, the water flow 902 may rise to a level higher than the axis (L) of the shaft 21, such that the upper vane portion 23 may be propelled by the water flow 902 and the torsion force of the drive unit 2 may be reduced. However, due to the lower vane portion 24 being entirely propelled by the water flow 902, the drive unit 2 can still be operated by the water flow 902.

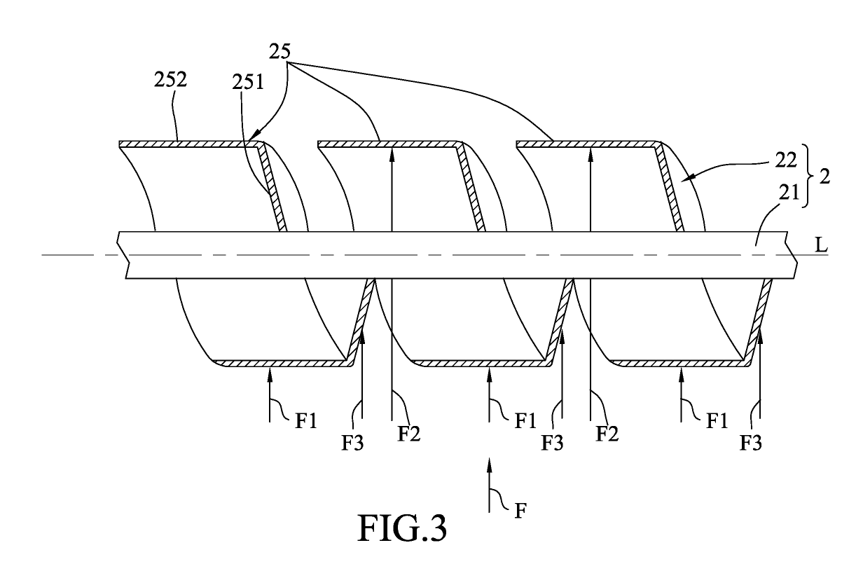

Referring back to FIG. 2 (only one of the helical rings 25 is shown), when the water flow 902 flows to the drive unit 2 in the direction (F), a part of the water flow 902 first contacts a front outer face of the surrounding wall 252, and produces a pushing force (F1) to push the vane unit 22 (See FIGS. 2 and 3).

At the same time, the other part of the water flow 902 flows through the gaps 20. Because the water flow 902 flows from the high-water level region 903 to the low-water level region 904, the water flow 902 may be accelerated by the height difference between the high-water and low-water level regions 903, 904. When the water flow 902 contacts the connection wall 251, it produces a pushing force (F3) to act on the connection wall 251 (see FIG. 3). When the water flow 902 contacts an inner face of the surrounding wall 252, it produces a pushing force (F2) to act on the inner face of the surrounding wall 252 (see FIG. 3).

By virtue of the structure of each helical ring 25, the water flow 902 may completely contact the vane unit 22 to transfer its kinetic energy to the vane unit 22.

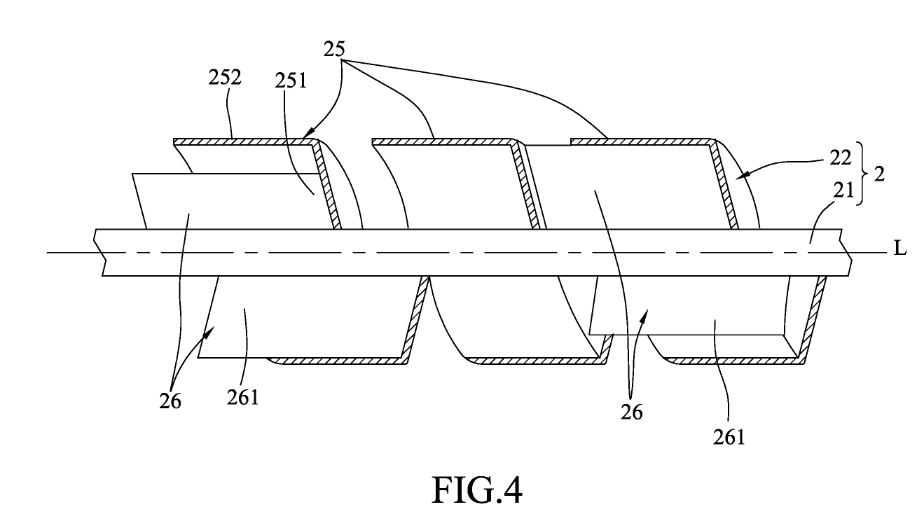

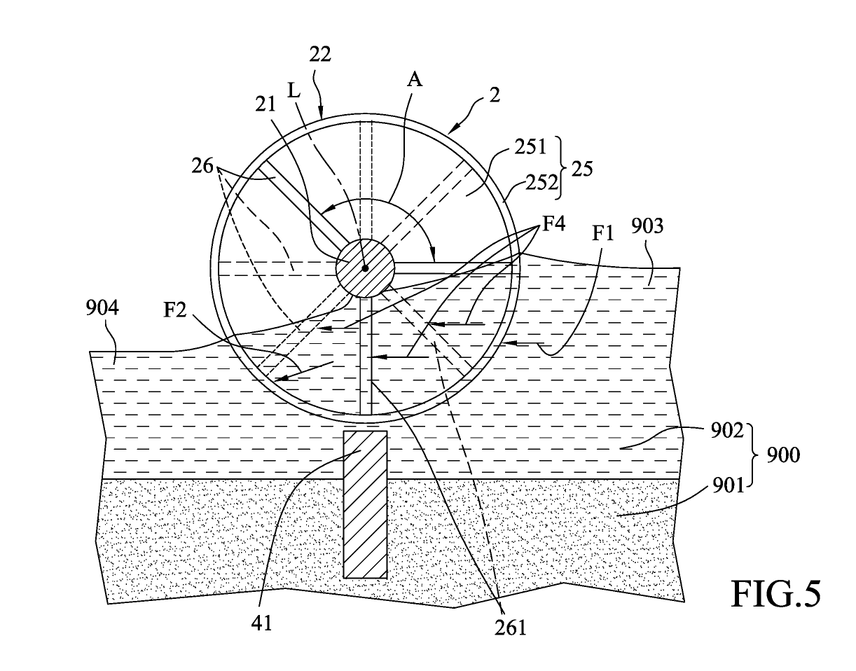

FIGS. 4 and 5 illustrate a second embodiment which differs from the first embodiment in that the drive unit 2 further includes a plurality of axially extending reinforcement plates 26 helically disposed around the shaft 21 and in the vane unit 22. Every two adjacent ones of the reinforcement plates 26 are spaced apart angularly by an included angle (A). Each reinforcement plate 26 is disposed inside one of the helical rings 25 and is connected to the shaft 21. In this embodiment, each reinforcement plate 26 is connected to the connection wall 251, the surrounding wall 252 of one of the helical rings 25 and the shaft 21. Each reinforcement plate 26 extends radially from the shaft 21 to the surrounding wall 252 and extends axially from the connecting wall 251. Therefore, the reinforcement plates 26 are firmly fixed to the vane unit 22 . In addition, each reinforcement plate 26 has a plate face 261 extending axially and radially.

Through the drive unit 2 having the reinforcement plates 26, when the water flow 902 flows through the gaps 20, the reinforcement plates 26 are subjected to a pushing force (F4) produced by the water flow 902 and are propelled to provide an additional torsion force for the vane unit 22 and the shaft 21. In this embodiment, the number of the helical rings 25 is three. The included angle (A) is 135 degrees. As such, the reinforcement plates 26 may evenly surround the shaft 21 and rotate together with the vane unit 22. There may be three or four reinforcement plates 26 located in the lower vane portion 24.

In addition, the vane unit 22 may further include a plurality of angularly spaced-apart blades (not shown) attached to the vane unit 22. Each blade may extend radially and outwardly from the vane unit 22 so that the drive unit 2 may function as a water mill to further provide a torsion force for the vane unit 22.

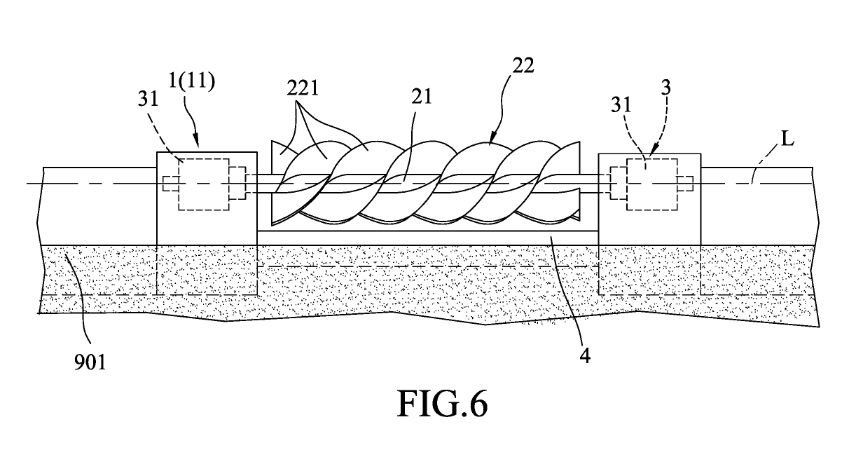

FIG. 6 illustrates a third embodiment which differs from the first embodiment in that the vane unit 22 includes six helical vanes 221 angularly spaced apart from each other and disposed around the shaft 21. The helical vanes 221 are arranged serially and helically along the shaft 21. Every two helical vanes 221 are spaced apart by 60 degrees from each other. Each helical vane 221 extends helically around the shaft 21 about 120 degrees.

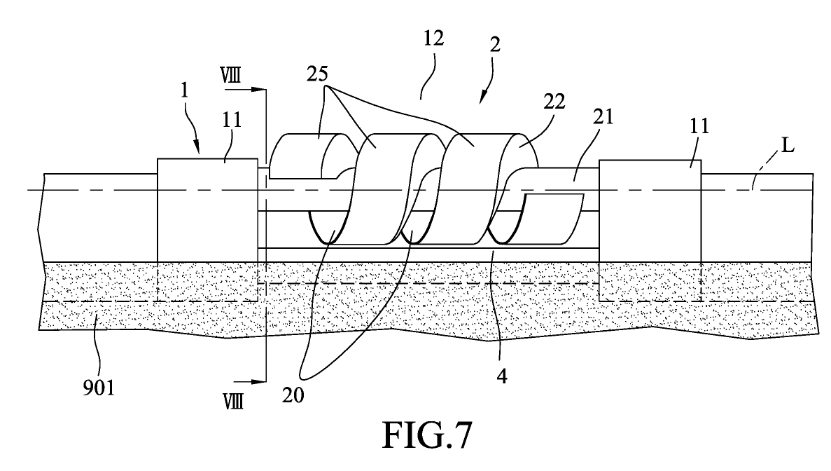

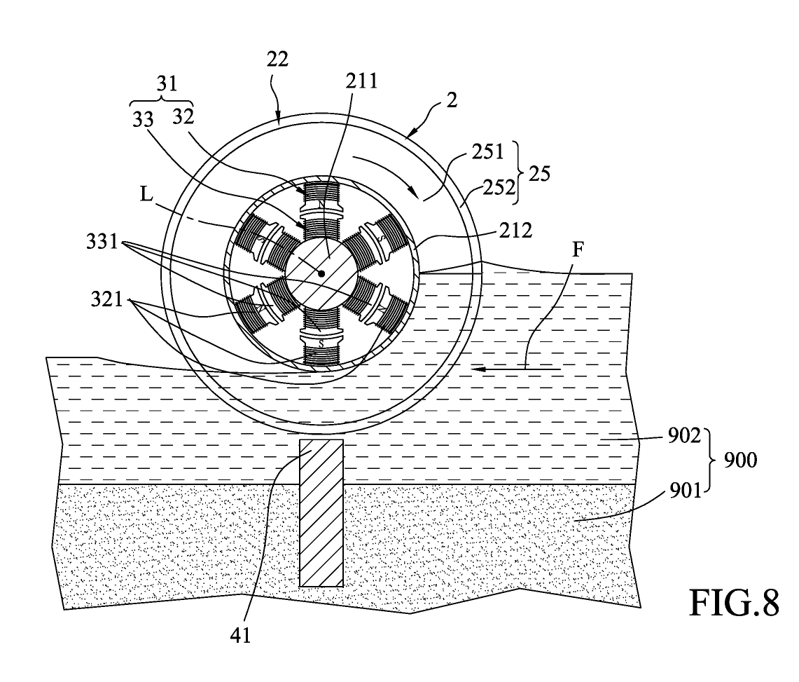

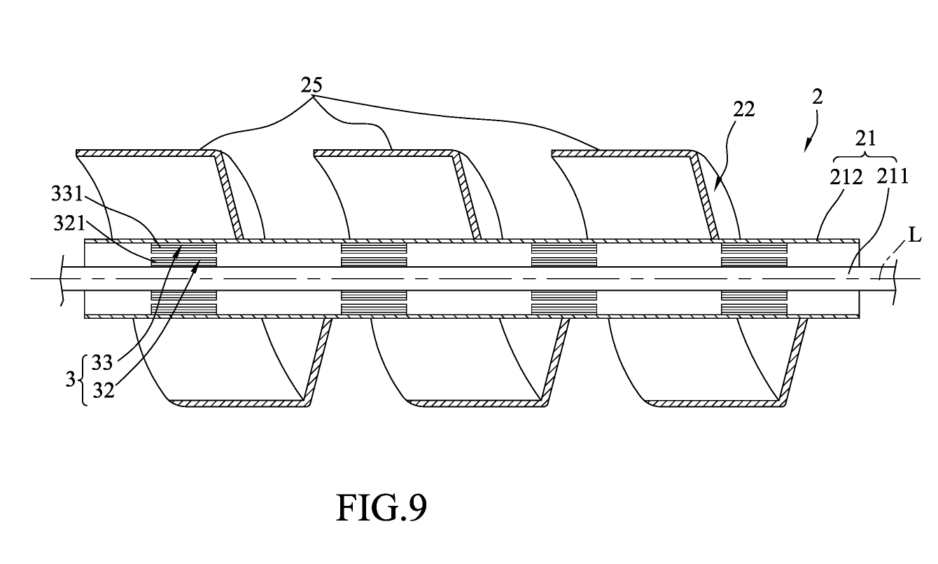

Referring to FIGS. 7 to 9, a fourth embodiment of the present disclosure is illustrated. In the fourth embodiment, the shaft 21 has an inner spindle 211 extending lengthwise along the axis (L) of the shaft 21, and a hollow spindle 212 extending lengthwise along the axis (L) and disposed rotatably around the inner spindle 211. The unit 22 extends helically around the hollow spindle 212. The power generation unit 3 includes one generator 31 disposed inside the hollow spindle 212. The generator 31 includes a rotator 32 disposed on an inner periphery of the hollow spindle 212, and a stator 33 disposed on an outer periphery of the inner spindle 211. The generator 31 generates power when the rotator 32 is driven by rotation of the hollow spindle 212 and rotates with respect to the stator 33.

In this embodiment, the rotator 32 has a plurality of magnet pairs 321 rotatably disposed around the inner spindle 211, and the stator 33 has a plurality of armature coils 331 disposed around the inner spindle 211. During the rotation of the rotator 32 with respect to the stator 33, the magnetic pairs 321 and the armature coils 331 cooperatively generate induced currents.

Alternatively, the stator 33 may have the magnetic pairs, and the rotator 32 may have the armature coils. The induced currents may be output through a plurality of sliding rings (not shown).

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A hydroelectric generation apparatus for being placed in a water body having a water flow comprising:
a dam unit including
a dam body to divide the water body into a high-water level region and a low-water level region, and
a flow passage formed in said dam body in fluid communication with the high-water and low-water level regions, said flow passage allowing the water flow to flow from the high-water level region to the low-water level region;
a drive unit including
a shaft disposed horizontally and rotatably in said flow passage and extending transversely of a flow direction of the water flow, and
a vane unit extending helically around said shaft, said vane unit having an upper vane portion above said shaft, and a lower vane portion beneath said shaft, said lower vane portion being propelled by the water flow to rotate said shaft; and
a power generation unit driven by said drive unit to generate power.

2. The hydroelectric generation apparatus as claimed in claim 1, wherein said vane unit has a plurality of helical rings axially spaced apart from one another, every two adjacent ones of said helical rings defining a gap therebetween.

3. The hydroelectric generation apparatus as claimed in claim 2, wherein each of said helical rings has a connection wall that is helically wound around and connected to said shaft and that is inclined to the flow direction of the water flow, and a surrounding wall that extends axially from said connection wall and that is spaced apart from said shaft.

4. The hydroelectric generation apparatus as claimed in claim 3, wherein said vane unit further includes a plurality of angularly and axially spaced-apart reinforcement plates each of which is disposed inside one of said helical rings and connected to said shaft.

5. The hydroelectric generation apparatus as claimed in claim 4, wherein each of said reinforcement plates is connected to said connecting wall and said surrounding wall, extends radially from said shaft to said surrounding wall, and extends axially from said connecting wall.

6. The hydroelectric generation apparatus as claimed in claim 6, wherein said vane unit includes a plurality of helical vanes angularly spaced apart from each other and disposed around said shaft.

7. The hydroelectric generation apparatus as claimed in claim 1, wherein:
said shaft has an inner spindle rod extending lengthwise along an axis of said shaft, and a hollow spindle extending lengthwise along said axis and disposed rotatably around said inner spindle;
said vane unit extends helically along and is connected around said hollow spindle; and
said power generation unit includes a rotator disposed on an inner periphery of said hollow spindle, and a stator disposed on an outer periphery of said inner spindle, said power generation unit generating power when said rotator is driven by rotation of said hollow spindle and rotates with respect to said stator.

8. The hydroelectric generation apparatus as claimed in claim 1, further comprising a streambed-protective unit disposed beneath said vane unit for protecting a part of a streambed of the water body below said vane unit.
